(19) United States
(12) Patent Application Publication
(10) Pub. No.: US 2023/0266720 A1
(43) Pub. Date: Aug. 24, 2023

(54) QUALITY AWARE MACHINE TEACHING FOR AUTONOMOUS PLATFORMS

(71) Applicant: MICROSOFT TECHNOLOGY LICENSING, LLC, Redmond, WA (US)

(72) Inventors: Kingsuk MAITRA, Fremont, CA (US); Garrett Patrick PRENDIVILLE, Sallins (IE); Hossein KHADIVI HERIS, Scotts Valley, CA (US); Jillian Marie CLEMENTS, Berkeley, CA (US); Kence ANDERSON, Berkeley, CA (US)

(21) Appl. No.: 17/840,533

(22) Filed: Jun. 14, 2022

Related U.S. Application Data
(60) Provisional application No. 63/313,607, filed on Feb. 24, 2022.

(51) Int. Cl. G05B 13/02

(52) U.S. Cl. CPC G05B 13/0265

(57) ABSTRACT

The techniques disclosed herein enable systems to enhance autonomous process control platforms using a quality aware machine learning agent. To achieve this, a machine learning agent is integrated into a process control system. The machine learning agent extracts a set of states from an environment containing the process and defines a set of corresponding quality states which are then extracted from the environment as well. Based on the set of states and quality states, the machine learning agent determines a set of actions that modify operating parameters of the process. Applying the actions results in an updated set of states and quality states which can be analyzed to compute an optimality score, quantifying the effectiveness of the actions. Based on the updated states and quality states, the machine learning agent determines a modified set of actions to apply to the environment and increase the optimality score.

### PRIORITY APPLICATION

The present application is a non-provisional application of, and claims priority to, U.S. Provisional Application Ser. No. 63/313,607 filed on Feb. 24, 2022, entitled: QUALITY AWARE MACHINE TEACHING FOR AUTONOMOUS PLATFORMS, the contents of which are hereby incorporated by reference in their entirety.

### BACKGROUND

As the scale and complexity of global supply chains and manufacturing has increased, various organizations have committed massive investments in the field of automated process control over the course of decades. In many examples, automated process control relates to the control of machinery involved in a manufacturing process such as chemical processing, semiconductor fabrication, and steel production. Automated process control can also be applied to the context of computing platforms such as a datacenter that provides cloud computing services. Thanks to advances in automated process control, many such processes in manufacturing and computing realize benefits in product throughput and efficiency respectively. This is thanks to reduced reliance on human oversight which can be inconsistent and prone to mistakes.

In recent times, many automated process control systems have been further enhanced with advanced computing techniques such as machine learning and artificial intelligence. These approaches enable systems to not only maintain consistent product throughput but even improve over time. In a specific example, an automated process control system can be augmented by a reinforcement learning model, commonly referred to as an RL brain. The reinforcement learning model can accordingly be configured with an objective or goal which is typically to optimize some aspect of the process. For instance, an operator of a manufacturing line may configure the reinforcement learning model to maximize product throughput. The reinforcement learning model can then modify various aspects of the manufacturing process such as the flow rate of raw materials or batch sizes. In doing so, the reinforcement learning model can iteratively learn a realistically optimal configuration of the manufacturing line to achieve the specified goal (e.g., maximum throughput). In contrast to an automated process control system, these systems can be referred to as autonomous platforms as the system is enabled to independently make decisions and adjust in real time.

However, while some autonomous approaches can dramatically improve certain aspects of a process such as throughput or efficiency, many existing solutions can be limited to a single objective or goal. For instance, the reinforcement learning model mentioned above may sacrifice product quality to maximize throughput. Stated another way, existing solutions can fail to account for tradeoffs between multiple aspects of a process and focus solely on optimizing a single aspect. This limitation can be highly detrimental to products that require strict quality standards for safety critical applications such as aerospace parts, semiconductors, and medical devices.

Accordingly, organizations that wish to fully reap the benefits of advanced computing techniques in autonomous platforms, must implement processes that can dynamically balance throughput or efficiency with final product quality. However, modifying existing processes to become quality-aware in addition to other factors can represent significant additional investment of time and resources. This can be infeasible in many contexts where interrupting a process can result in lost revenue and a damaged reputation. Thus, there is a need for seamless integration of quality metrics in autonomous platforms for process control.

It is with respect to these and other considerations that the disclosure made herein is presented.

### SUMMARY

The techniques disclosed herein improve the functionality of systems for autonomous process control through the introduction of quality awareness in a machine learning agent. Generally described, a process can comprise several states that describe some aspect of the process such as a meter that collects and displays a reading. For each state, a corresponding action may be defined that directly controls or otherwise modifies the state. In a specific example, the process can be a manufacturing line where the state is a flow rate of raw materials. Naturally, the corresponding action is to increase or decrease the flow rate of raw materials. When applying a machine learning agent to autonomously control the process, the machine learning agent can be accordingly enabled to construct various actions that modify associated states within the process.

In various examples, a machine learning agent can extract a set of states from an environment that contains various components that comprise the process. For instance, the environment can be a manufacturing line comprising several manufacturing implements. The states can define various characteristics of the manufacturing implements such as the flow rate of raw materials mentioned above. Information extracted from these manufacturing implements can make up the states that inform decision-making at the machine learning agent. It should be understood that the machine learning agent can utilize any suitable approach such as deep reinforcement learning, supervised learning, unsupervised learning, and the like.

Based on the extracted states, the machine learning agent can define and extract an additional set of quality states that correspond to some, or all of the set of states extracted from the environment. As will be elaborated upon below, the quality states can serve to constrain various parameters of the environment subject to a predetermined level of quality. In addition, the quality states can be utilized by the machine learning agent to quantify the quality of final products. In various examples, the machine learning agent can be configured to optimize for quality in addition to throughput or other factors while providing insight on the various tradeoffs of each factor.

By illuminating the tradeoffs between various factors such as throughput and quality, the machine learning agent can enable an administrative entity such as a process engineer to configure the machine learning agent in an informed manner. For instance, an operator may define a minimum and a maximum quality levels or specification limits which the machine learning agent must operate within. These predetermined quality levels can be configured with the knowledge that throughput may be impacted depending on the selected quality level.

Using the states and quality states extracted from the environment as well as the predetermined quality levels, the machine learning agent can determine various actions for application within the environment. For instance, by analyzing of the states and quality states, the machine learning agent may determine that decreasing the flow rate of raw materials leads to increased quality with a corresponding decrease in throughput. However, such an action may be necessary to maintain a quality that is within the predefined quality levels.

As the various actions are executed within the environment, the machine learning agent can quantify the success of those actions using an optimality score. In various examples, the optimality scores can be calculated using an updated set of states and quality states and can include values quantifying various factors such as throughput and quality. Optimality scores can be calculated in various such as using a reward function or a goal function that incorporates the various factors mentioned above. Based on the optimality score, the machine learning agent can determine a modified set of actions that aim to increase the optimality score while maintaining product quality as defined by the predetermined quality levels.

As mentioned above, typical approaches to autonomous platforms merely optimize a process for a single aspect such as throughput or efficiency and can thus be limited in improving a whole process. In some examples, such approaches can even be detrimental to the process as quality may be sacrificed to achieve greater throughput. In contrast to existing solutions, integrating quality awareness to an autonomous platform as described herein enables process control systems to dynamically assess tradeoffs between various factors of a process. In this way, decisions made by the autonomous platform can optimize the process for each configured factor. In other words, the goal function mentioned above can be defined to encompass several interconnected factors such as throughput, efficiency, and quality.

By integrating autonomous quality awareness with a machine learning agent in this manner, operators can augment existing process control systems with little or no additional investment. As mentioned above, seamless integration of quality awareness is a crucial consideration for operators as drastic changes or disruptions to an existing process can be highly detrimental to overall business operations. In one example, many existing process control systems do not include any mechanisms for quality checks or bounds. In these circumstances, augmenting the system with a quality aware machine learning agent can fulfill a dual purpose of enforcing quality standards defined by an operator such as Six Sigma in addition to optimizing process operations for throughput or efficiency.

In another example of the technical benefit of the present disclosure, the disclosed techniques can dramatically streamline existing quality processes. For example, an existing process may include various quality assurance mechanisms. Unfortunately, many existing quality protocols are highly manual processes that can be extremely time-consuming and labor intensive. Consider for instance, a process for manufacturing of optical devices which require strict quality standards. Accordingly, assessing product quality requires complex machinery and significant human effort as well. As such, final product throughput is limited by the pace of quality checks. In contrast, by introducing quality awareness to the manufacturing process itself, the disclosed system can streamline or even eliminate process bottlenecks introduced by existing quality checks.

In still another example of the technical benefit of the present disclosure, by integrating quality awareness to the machine learning agent, the disclosed system can greatly simplify data driven simulators for constructing environmental models. In many contexts, a virtual environmental model of the environment is extremely useful for training and configuring various aspects of an autonomous platform for process control. In typical solutions, constructing the environmental model requires a significant amount of data that may not always be feasible to collect. Using predefined quality levels, target specifications, and known operating distributions of the environment, an operator can generate an effective environmental model using a limited existing dataset. In addition, various states within the simulated environment model can be retroactively generated by the machine learning agent to bolster the simulation.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of a system for integrating quality awareness in a machine learning agent for autonomous control of a manufacturing process.

FIG. 2 is a block diagram of a system for integrating quality awareness in a machine learning agent for autonomous control of a computing environment.

FIG. 3 is a block diagram a quality aware machine learning agent for autonomous control systems.

FIG. 4 is a flow diagram showing aspects of a routine for integrating quality awareness in machine learning agents for autonomous platforms.

FIG. 5 is a computer architecture diagram illustrating an illustrative computer hardware and software architecture for a computing system capable of implementing aspects of the techniques and technologies presented herein.

FIG. 6 is a diagram illustrating a distributed computing environment capable of implementing aspects of the techniques and technologies presented herein.

### DETAILED DESCRIPTION

The techniques described herein provide systems for enhancing process control platforms through the introduction of autonomous control capabilities and quality awareness in a machine learning agent. As mentioned above, the machine learning agent can extract information from an environment such as a manufacturing line or a computing environment and construct various actions to apply to the environment. It should be understood that an autonomous platform as discussed herein differs from an automated control system in that an autonomous platform can be enabled to make decisions based on information extracted from the environment.

The disclosed system addresses several technical challenges associated with autonomous platforms and enabling quality awareness for process control. For example, some existing autonomous platforms can be limited to optimizing individual aspects of a process such as product throughput of a manufacturing line or efficiency of a computing system. As such, these solutions may make decisions that are counterproductive to the overall goal of the process. For instance, an autonomous platform may increase the flow rate of raw material in a manufacturing line to maximize product throughput. However, this decision may lead to reduced product quality. In some contexts where product quality is not a major concern such as low-cost consumer products, such a decision may be desirable. Conversely, for products in which final quality is a high priority such as semiconductors, aerospace components, and optical devices, the decisions of the autonomous platform may lead to disruptions to production and lost revenue for process operators. In contrast, the disclosed system can integrate a diverse set of quality metrics that enable the system to intelligently balance multiple factors of a process to learn a realistically optimal configuration.

Furthermore, the disclosed system can greatly streamline existing quality assurance mechanisms. As mentioned above, many quality checks are highly manual processes that can negatively affect product throughput. For instance, quality assurance for optical devices requires extensive training and manual effort. By introducing quality awareness to manufacturing and/or computing processes themselves, the disclosed system can reduce or even eliminate the additional time required assess final product quality.

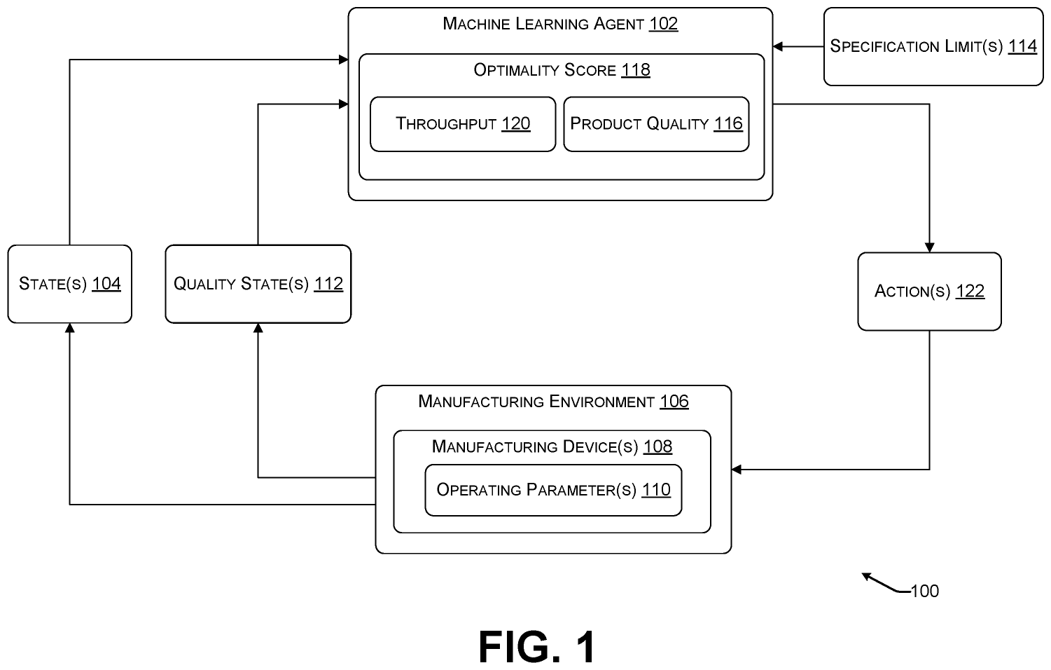

Various examples, scenarios, and aspects that enable quality aware machine learning in autonomous platforms, are described below with reference to FIGS. 1-6.

FIG. 1 illustrates an example routine 100 in which a machine learning agent 102 extracts a set of states 104 from a manufacturing environment 106 containing manufacturing devices 108. The set of states 104 can define various operating parameters 110 of the manufacturing devices 108 within the manufacturing environment 106 such as the flow rate of raw materials mentioned above. For the sake of discussion, it is helpful to consider the set of states 104 as meters that collect and display information pertaining to the manufacturing environment 106. It should be understood that the manufacturing devices 108 can be any component of a manufacturing process such as assembly line devices, resource processing machinery, and the like. As will be discussed below, the disclosed techniques can also apply to computing systems that are not part of a manufacturing process. As such, the techniques discussed herein can be applied to a computing “environment” or a “computing system.”

Based on the various states 104 extracted from the manufacturing environment 106, an additional set of quality states 112 can be defined that correspond to some, or all of the set of states 104. These quality states 112 can be utilized to augment or constrain ways in which the machine learning agent 102 interacts with the manufacturing environment 106 to alter the states 104. In various examples, an individual quality state 112 can be defined using the following equation:

$${C}_{PK} ( {s}_{i} ) = MIN ( \frac{[ {USL}_{i} - {μ}_{i} ]}{3 {σ}_{i}} , \frac{[ {μ}_{i} - {LSL}_{i} ]}{3 {σ}_{i}} )$$

Where Cₚₖ is a quality state 112 corresponding to sᵢ, a state 104. USL and LSL are an upper and lower specification limit 114 defined by an administrative entity which can also be understood as predefined quality levels that the final product of the process must conform to. Stated another way, the specification limits 114 define acceptable boundaries for various measures of quality such as power consumption, deformation, size and so forth. Ideally, as will be discussed below, products produced by the manufacturing environment 106 fall in the center between the upper and lower specification limits 114. Indeed, an effective process will tend towards a center between the upper and lower specification limits 114 as the it and the resultant product matures. Stated another way, an optimal process involves centering aspects of the product within the bounds defined by the specification limits 114. Furthermore, in the context of statistical quality control, u is a mean of the process in relation to the specification limits 114 defined by the USL and LSL while a is a standard deviation from the mean. In various examples a greater value of Cₚₖ indicates a higher level of quality (e.g., stricter requirements).

In the context of statistical quality control, Cₚₖ can be a measure of a product quality 116 in relation to a statistical distribution representing the process range of a manufacturing process. Accordingly, Cₚₖ can be defined using the following equation:

$${C}_{p k} = min \frac{USL - μ , μ - LSL}{3 {σ}_{c}}$$

Where min

$$\frac{USL - μ , μ - LSL}{3 {σ}_{c}}$$

represents a distance from the process average to the closest specification limit 114 and 3σ_{c} represents three standard deviations from the mean of the process. In other words, 3σ_{c} represents one half of the full process range. In various examples a Cₚₖ of less than 1.0 can indicate that the process (e.g., the manufacturing environment 106) is not capable of adhering to the specification limits 114. As such, a Cₚₖ that is equal to 1.0 can indicate that the process is marginally capable of meeting specifications. Finally, a Cₚₖ that is greater than 1.0 can indicate that the process is capable of consistently meeting specifications limits 114. In many contexts, an operator of the manufacturing environment 106 may desire a Cₚₖ≥1.33 for important components or products such as mechanical fasteners. However, for highly sensitive applications in which quality is of utmost concern, an operator may desire a Cₚₖ≥2.0 often referred to as a Six Sigma requirement. These values of Cₚₖ can be configured by an administrative entity such as a technician or a process engineer to constrain the outputs constructed by the machine learning agent 102 within a predetermined level of quality.

Once the various quality states 112 are defined, the machine learning agent 102 can accordingly extract the relevant information from the manufacturing environment 106. For example, the machine learning agent 102 may control a whole manufacturing process of the manufacturing environment 106. Accordingly, the machine learning agent 102 can extract states 104 for every manufacturing device 108 within the manufacturing environment 106. Conversely, the machine learning agent 102 may only control a portion of the process such as an assembly line while another machine learning agent controls manufacturing devices 108 for processing raw materials. As such, the machine learning agent 102 only extracts states 104 for a subset of the manufacturing devices 108 for which is controls.

Using the set of states 104 and quality states 112, the machine learning agent 102 can calculate an optimality score 118 to quantify the effectiveness of the manufacturing environment 106 as it is currently operating. In various examples, the optimality score 118 captures various factors such as throughput 120 and product quality 116. Based on this assessment of the manufacturing environment, the machine learning mode can construct a set of actions 122 to apply to the manufacturing environment 106. Specifically, the actions 122 pertain to modifying the operating parameters 110 of the manufacturing devices 108. As mentioned above, a state 104 can be considered as a meter capturing and displaying information regarding the manufacturing environment 106. Accordingly, an action 122 can be accordingly conceptualized as a dial that adjusts the information displayed by the meter.

In this way, through several iterations, the machine learning agent 102 can illuminate the complex interactions and associated tradeoffs between various aspects of the manufacturing environment 106. For instance, an increased emphasis on product quality 116 may lead to a decrease in throughput 120 (e.g., fewer products can be made in a given period of time). However, such tradeoffs can be objectively quantified by the machine learning agent 102 to enable an administrative entity to decide on optimal specification limits or predefined quality levels. As such, once a set of goals or a goal function is defined, the machine learning agent 102 may be configured to seek a maximal optimality score 118 that considers both throughput 120 and product quality 116 of the manufacturing environment 106. Accordingly, the machine learning agent 102 can be configured to continually perform quality checks while managing the manufacturing environment 106 to update the quality states 112. Consequently, if a product quality 116 does not meet the level of quality defined by the specification limits 114, the associated product can be discarded and/or modified to conform to the specification limits 114.

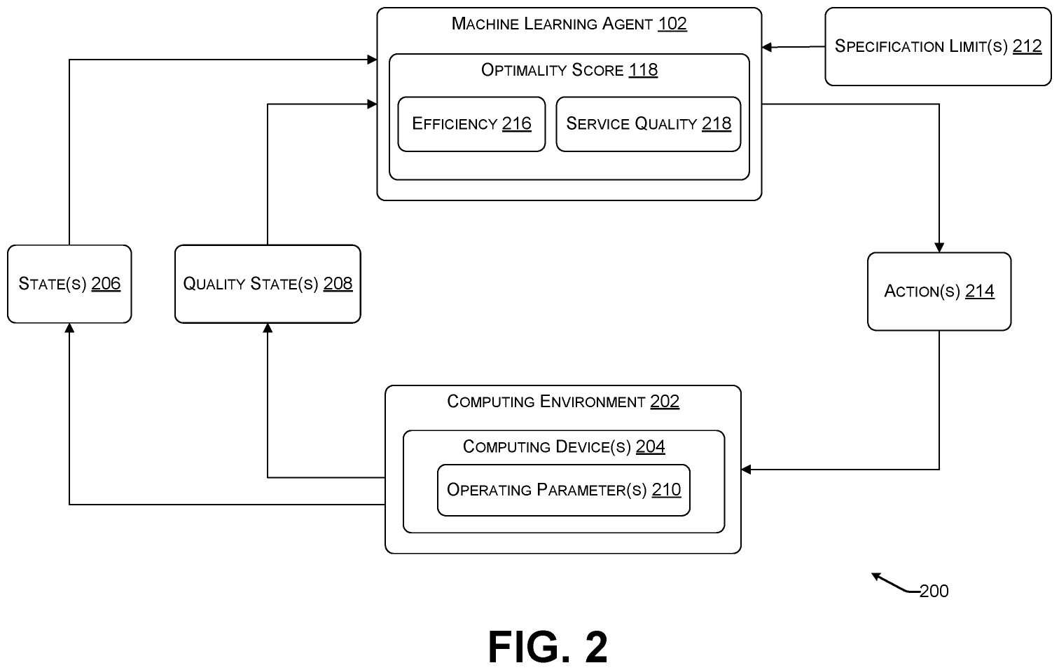

Turning now to FIG. 2, a similar routine 200 is shown in which the principles described above with respect to a manufacturing environment 106 are applied to a computing environment 202. In various examples, the computing environment 202 can include various computing devices 204 that provide network services, cloud computing capabilities, and other computing infrastructure. As such, the computing environment 202 can include many complex processes which are overseen by automated or autonomous methods such as the machine learning agent 102. Accordingly, the computing environment can reap similar benefits as the manufacturing environment 106 using a quality aware approach with the machine learning agent 102.

Similar to the example discussed above, a machine learning agent 102 can extract a set of states 206 and quality states 208 from the computing environment. While a state 104 in the context of FIG. 1 may pertain to physical parameters of a manufacturing implement such as a flow rate, a state 206 of a computing environment 202 may define a clock speed of a computing core or other operating parameters 208 of a computing device 204. Similarly, a quality state 208 corresponding to the state 206 may quantify a relationship between an associated clock speed state 206 to a maximum and minimum clock speed set by the specification limits 210. Accordingly, the actions 212 constructed by the machine learning agent 102 can be configured to adjust the clock speed of the computing core among other operating parameters 210.

In various examples, the optimality score 118 calculated by the machine learning agent 102 can be configured to the specific needs of the computing environment 202. As shown in FIG. 2, the optimality score 118 encompass the efficiency 216 and service quality 218 the computing environment 202. For instance, efficiency 216 may quantify the consumption of computing resources (e.g., cores, memory) in relation to active computing tasks. In addition, service quality 218 may pertain to the total uptime of a cloud service in relation to service disruptions or slowdowns. It should be understood that efficiency 216 and service quality 218 can utilize any applicable metric to quantify performance of the computing environment 202. For example, service quality 218 can be expressed through various quality of service (QoS) metrics that relate to packet loss, transmission, availability, and so forth.

Accordingly, the machine learning agent 102 can be configured to maximize the optimality score 118 through various iterations of the actions 214 while accounting for efficiency 216 and service quality 218. In an illustrative example, a machine learning agent 102 that is configured to only maximize efficiency 216 may construct actions 214 that configure the operating parameters 210 to assign minimal computing resources for tasks executed by the computing devices 204. However, while efficiency 216 may be high in this situation due to the minimal resource consumption, the computing tasks may suffer from resource starvation due to the inadequate resource allocation provided by this naïve implementation of the machine learning agent 102 thereby degrading service quality 218 and the user experience.

In contrast, by incorporating quality awareness to the machine learning agent 102, the actions 214 can balance tradeoffs between efficiency 216 and service quality 218. Consequently, while the efficiency 216 may not be completely maximized, the machine learning agent 102 can maximize the efficiency 216 subject to a predetermined level of quality defined by the specification limits 212 and quantified by the service quality 218. In addition, the machine learning agent 102 can be configured to monitor the computing environment 202 by extracting updated states 206 and quality states 208. In one example, the machine learning agent 102 may determine that the service quality 218 does not meet the level of quality defined by the specification limits 212. For instance, packet loss at the computing environment 202 may exceed a threshold of acceptable packet loss. In response, the machine learning agent 102 can construct modified actions 214 that adjust the operating parameters 210 of the computing devices 204 to address the cause of decreased service quality 218 (e.g., packet loss).

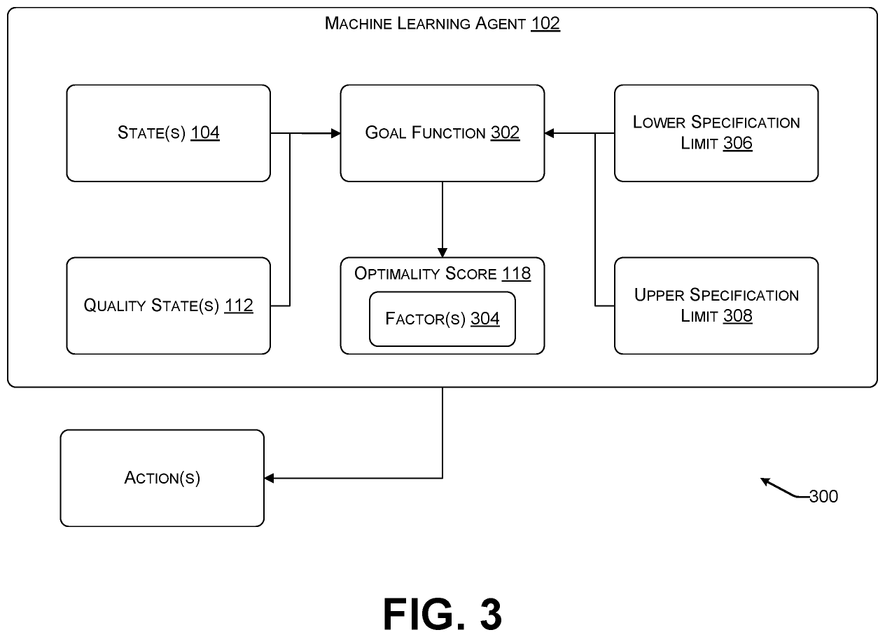

Turning now to FIG. 3, aspects of the machine learning agent 102 are shown and described. As mentioned above, the machine learning agent 102 can be configured to extract a set of states 104 and corresponding quality states 112 from an environment such as the manufacturing environment 106 or a computing environment 202. To configure the machine learning agent 102, an administrative entity such as a technician or system engineer defines a goal function 302. In various examples, the goal function 302 can also be referred to as a reward construct and defines the various factors 304 that comprise the optimality score 118. In the context of a manufacturing environment 106, the factors 304 can be product throughput 120 and product quality 116 as discussed above. For a computing environment 202, the factors 304 can be efficiency 216 and service quality 218.

Using the goal function 302, the machine learning agent can calculate an optimality score 118 based on the set of states 104 and quality states 112. The optimality score 118 can quantify a relationship between the states 104, quality states 112 and the specification limits 114. As shown, the machine learning agent 102 can be configured with a lower specification limit 306 and an upper specification limit 308. In one example, for a predetermined level of quality Cₚₖ (sᵢ) that is greater than 1.33, the optimality score 118 can be computed using the following equation:

R=minimize(F₁)+maximize(F₂)+ . . .

Where the R is the optimality score 118, and where F₁ and F₂ are the factors 304. It should be understood that the optimality score 118 can be computed using any number of factors 304 and that the machine learning agent 102 can be configured to maximize or minimize each factor 304 as necessary. For example, the machine learning agent 102 may be configured to minimize energy consumption for manufacturing environment 106 while maximizing throughput 120. In an alternative example, the machine learning model 102 can be configured to maximize throughput 120 and maximize product quality 116.

In addition, the machine learning agent can determine various actions 310 that can be applied to a control system such as the manufacturing environment 106 or the computing environment 202. As discussed above, the actions can modify operating parameters 110 for manufacturing devices 108, operating parameters 210 for computing devices 204, and so forth. Through multiple iterations, the machine learning agent 102 can determine a realistically optimal configuration of actions 310 that leads to a maximal optimality score 118. In addition, it should be understood that the equation provided above is merely an illustrative example and that any equation may be used to calculate a reward for quantifying the success of various actions 310 for a given control system.

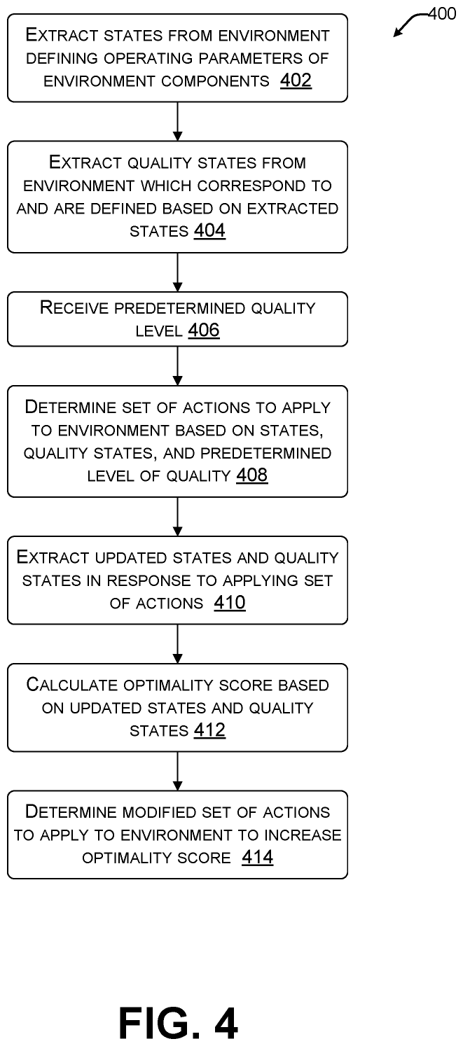

Turning now to FIG. 4, aspects of a routine 400 for enabling quality awareness in machine learning agents for autonomous platforms are shown and described. For ease of understanding, the processes discussed in this disclosure are delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 400 are described herein as being implemented, at least in part, by modules running the features disclosed herein can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the components of the figures, it should be appreciated that the operations of the routine 400 may be also implemented in many other ways. For example, the routine 400 may be implemented, at least in part, by a processor of another remote computer or a local circuit. In addition, one or more of the operations of the routine 400 may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

With reference to FIG. 4, the routine 400 begins at operation 402 where a machine learning agent extracts a set of states from an environment in which the set of states define various operating parameters of the environment. As mentioned above, the environment can be a manufacturing environment or a computing environment. Accordingly, the states can relate to various properties of their respective environments such as a flow rate of raw material in the manufacturing environment or a clock speed in the computing environment.

Next, at operation 404, a set of quality states is extracted from the environment. As mentioned above, the quality states can pertain to some, or all of the set of states originally extracted from the environment. These quality states can serve to bound or augment the information defined by the set of states.

Subsequently, at operation 406, the machine learning agent can receive a predetermined level of quality from an administrative entity. The predetermined level of quality can be a minimum quality of a final product or constraints that the machine learning agent must operate within such as a minimum and a maximum quality (e.g., lower specification limit and upper specification limit).

Then, at operation 408, the machine learning agent determines a set of actions to apply to the environment based on the states, quality states, and predetermined level of quality. These actions can modify various operating parameters of the environment such as flow rate of raw material or clock speed.

Next, at operation 410, the machine learning agent extracts an updated set of states and quality states from the environment in response to applying the set of actions. As in the meter and dial analogy mentioned above, an action can be anything that changes a value of the dial to modify information captured by the meter within the environment. As such, the machine learning agent can be configured to measure changes caused by the actions.

Then, at operation 412, the machine learning agent calculates an optimality score based on the updated states and updated quality states. The optimality score can include aspects of the environment such as throughput and product quality in manufacturing context, or efficiency and service quality in a computing context. Each aspect can be calculated according to its associated set of states. For instance, product quality can be calculated based on the updated quality states while throughput can be calculated based on the updated states.

Finally, at operation 414, the machine learning agent determines a modified set of actions to apply to the environment with the goal of increasing the optimality score. In this way, the machine learning agent can iteratively improve over time to learn a feasibly optimal configuration of the environment to maximize the optimality score. In various examples, a maximal optimality score can indicate an optimal balance between the various aspects encompassed by the optimality score such as throughput and product quality.

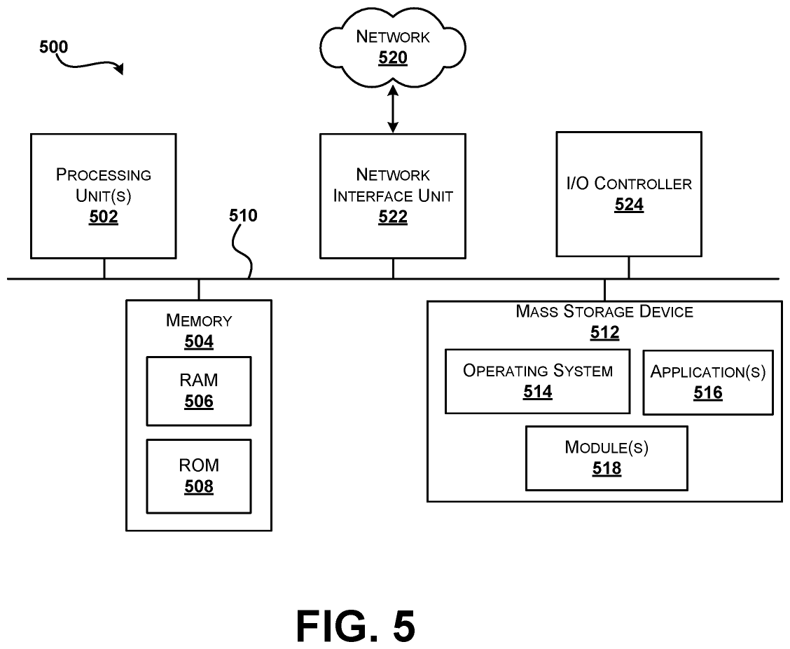

FIG. 5 shows additional details of an example computer architecture 500 for a device, such as a computer or a server configured as part of the cloud-based platform or system 100, capable of executing computer instructions (e.g., a module or a program component described herein). The computer architecture 500 illustrated in FIG. 5 includes processing unit(s) 502, a system memory 504, including a random-access memory 506 (“RAM”) and a read-only memory (“ROM”) 508, and a system bus 510 that couples the memory 504 to the processing unit(s) 502.

Processing unit(s), such as processing unit(s) 502, can represent, for example, a CPU-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 500, such as during startup, is stored in the ROM 508. The computer architecture 500 further includes a mass storage device 512 for storing an operating system 514, application(s) 516, modules 518, and other data described herein.

The mass storage device 512 is connected to processing unit(s) 502 through a mass storage controller connected to the bus 510. The mass storage device 512 and its associated computer-readable media provide non-volatile storage for the computer architecture 500. Although the description of computer-readable media contained herein refers to a mass storage device, it should be appreciated by those skilled in the art that computer-readable media can be any available computer-readable storage media or communication media that can be accessed by the computer architecture 500.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 500 may operate in a networked environment using logical connections to remote computers through the network 520. The computer architecture 500 may connect to the network 520 through a network interface unit 522 connected to the bus 510. The computer architecture 500 also may include an input/output controller 524 for receiving and processing input from a number of other devices, including a keyboard, mouse, touch, or electronic stylus or pen. Similarly, the input/output controller 524 may provide output to a display screen, a printer, or other type of output device.

It should be appreciated that the software components described herein may, when loaded into the processing unit(s) 502 and executed, transform the processing unit(s) 502 and the overall computer architecture 500 from a general-purpose computing system into a special-purpose computing system customized to facilitate the functionality presented herein. The processing unit(s) 502 may be constructed from any number of transistors or other discrete circuit elements, which may individually or collectively assume any number of states. More specifically, the processing unit(s) 502 may operate as a finite-state machine, in response to executable instructions contained within the software modules disclosed herein. These computer-executable instructions may transform the processing unit(s) 502 by specifying how the processing unit(s) 502 transition between states, thereby transforming the transistors or other discrete hardware elements constituting the processing unit(s) 502.

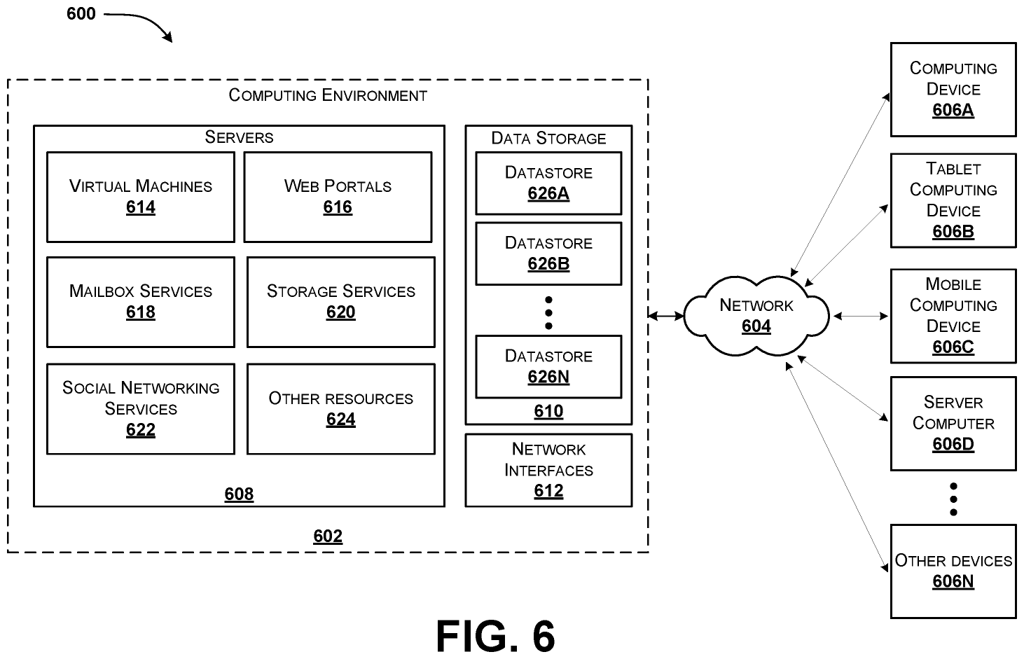

FIG. 6 depicts an illustrative distributed computing environment 600 capable of executing the software components described herein. Thus, the distributed computing environment 600 illustrated in FIG. 6 can be utilized to execute any aspects of the software components presented herein. For example, the distributed computing environment 600 can be utilized to execute aspects of the software components described herein.

Accordingly, the distributed computing environment 600 can include a computing environment 602 operating on, in communication with, or as part of the network 604. The network 604 can include various access networks. One or more client devices 606A-606N (hereinafter referred to collectively and/or generically as “clients 606” and also referred to herein as computing devices 606) can communicate with the computing environment 602 via the network 604. In one illustrated configuration, the clients 606 include a computing device 606A such as a laptop computer, a desktop computer, or other computing device; a slate or tablet computing device (“tablet computing device”) 606B; a mobile computing device 606C such as a mobile telephone, a smart phone, or other mobile computing device; a server computer 606D; and/or other devices 606N. It should be understood that any number of clients 606 can communicate with the computing environment 602.

In various examples, the computing environment 602 includes servers 608, data storage 610, and one or more network interfaces 612. The servers 608 can host various services, virtual machines, portals, and/or other resources. In the illustrated configuration, the servers 608 host virtual machines 614, Web portals 616, mailbox services 618, storage services 620, and/or, social networking services 622. As shown in FIG. 6 the servers 608 also can host other services, applications, portals, and/or other resources (“other resources”) 624.

As mentioned above, the computing environment 602 can include the data storage 610. According to various implementations, the functionality of the data storage 610 is provided by one or more databases operating on, or in communication with, the network 604. The functionality of the data storage 610 also can be provided by one or more servers configured to host data for the computing environment 600. The data storage 610 can include, host, or provide one or more real or virtual datastores 626A-626N (hereinafter referred to collectively and/or generically as “datastores 626”). The datastores 626 are configured to host data used or created by the servers 808 and/or other data. That is, the datastores 626 also can host or store web page documents, word documents, presentation documents, data structures, algorithms for execution by a recommendation engine, and/or other data utilized by any application program. Aspects of the datastores 626 may be associated with a service for storing files.

The computing environment 602 can communicate with, or be accessed by, the network interfaces 612. The network interfaces 612 can include various types of network hardware and software for supporting communications between two or more computing devices including, but not limited to, the computing devices and the servers. It should be appreciated that the network interfaces 612 also may be utilized to connect to other types of networks and/or computer systems.

It should be understood that the distributed computing environment 600 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 600 provides the software functionality described herein as a service to the computing devices. It should be understood that the computing devices can include real or virtual machines including, but not limited to, server computers, web servers, personal computers, mobile computing devices, smart phones, and/or other devices. As such, various configurations of the concepts and technologies disclosed herein enable any device configured to access the distributed computing environment 600 to utilize the functionality described herein for providing the techniques disclosed herein, among other aspects.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for optimizing a manufacturing process comprising:
extracting, using a machine learning agent, a plurality of states from a manufacturing environment comprising one or more manufacturing implements, the plurality of states defining one or more operating parameters of the one or more manufacturing implements;
extracting a plurality of quality states from the environment, wherein each quality state of the plurality of quality states is defined based on a corresponding state of the plurality of states extracted from the manufacturing environment;
receiving a predetermined level of quality from an administrative entity;
determining, using the machine learning agent, a set of one or more actions for application to the manufacturing environment based on the plurality of states, the plurality of quality states, and the predetermined level of quality for modifying one or more operating parameters of the one or more manufacturing implements;
extracting an updated plurality of states and an updated plurality of quality states in response to applying the one or more actions to the manufacturing environment;
calculating an optimality score comprising a throughput of the manufacturing environment based on the updated plurality of states and a level of quality based on the updated plurality of quality states; and
determining a modified set of one or more actions for application to the manufacturing environment based on the updated plurality of states and the updated plurality of quality states to increase the optimality score.

2. The method of claim 1, wherein the level of optimality is a numerical score comprising a first score that is calculated based on the updated plurality of state and a second score that is calculated based on the updated plurality of quality states.

3. The method of claim 1, wherein the plurality of quality states quantifies a relationship between a product quality of the manufacturing environment and the predetermined level of quality.

4. The method of claim 1, wherein the predetermined level of quality comprises an upper specification limit and a lower specification limit.

5. The method of claim 1, wherein increasing the level of optimality comprises centering a product quality of the manufacturing environment between an upper specification limit and a lower specification limit.

6. The method of claim 1, wherein the plurality of quality states constrains the set of one or more actions determined by the machine learning agent.

7. The method of claim 1, further comprising:
determining that a product quality of the manufacturing environment is below the predetermined level of quality; and
in response to determining that the product quality of the manufacturing environment is below the predetermined level of quality discarding the product of the manufacturing environment.

8. A method for optimizing operations of a computing environment comprising:
extracting, using one or more processing units, a plurality of states from the computing environment comprising one or more computing devices, the plurality of states defining one or more operating parameters of the one or more computing devices;
deriving a plurality of quality states based on the plurality of states extracted from the computing environment, wherein each quality state of the plurality of quality states is defined based on a corresponding state of the plurality of states extracted from the computing environment;
receiving a predetermined level of quality from an administrative entity; and
determining, using the machine learning mode, one or more actions for application to the manufacturing environment based on the plurality of states, the plurality of quality states, and the predetermined level of quality for modifying one or more operating parameters of the one or more computing devices.

9. The method of claim 8, wherein the level of optimality is a numerical score comprising a first score that is calculated based on the updated plurality of state and a second score that is calculated based on the updated plurality of quality states.

10. The method of claim 8, wherein the plurality of quality states quantifies a relationship between a service quality of the computing environment and the predetermined level of quality.

11. The method of claim 8, wherein the predetermined level of quality comprises an upper specification limit and a lower specification limit.

12. The method of claim 8, wherein increasing the level of optimality comprises centering a service quality of the computing environment between an upper specification limit and a lower specification limit.

13. The method of claim 8, wherein the plurality of quality states constrains the set of one or more actions determined by the machine learning agent.

14. The method of claim 8, further comprising:
extracting an updated plurality of states and an updated plurality of quality states in response to applying the one or more actions to the computing environment;
calculating an optimality score comprising an efficiency of the computing environment based on the updated plurality of states and a level of service quality based on the updated plurality of quality states; and
determining a modified set of one or more actions for application to the manufacturing environment based on the updated plurality of states and the updated plurality of quality states to increase the optimality score.

15. A system comprising:
One or more processing units; and
A computer-readable medium having encoded thereon computer-readable instructions that when executed by the one or more processing units cause the system to:
extract, using one or more processing units, a plurality of states from the computing environment comprising one or more computing devices, the plurality of states defining one or more operating parameters of the one or more computing devices;
derive a plurality of quality states based on the plurality of states extracted from the computing environment, wherein each quality state of the plurality of quality states is defined based on a corresponding state of the plurality of states extracted from the computing environment;
receive a predetermined level of quality from an administrative entity; and
determine, using the machine learning mode, one or more actions for application to the manufacturing environment based on the plurality of states, the plurality of quality states, and the predetermined level of quality for modifying one or more operating parameters of the one or more computing devices.

16. The system of claim 15, wherein the level of optimality is a numerical score comprising a first score that is calculated based on the updated plurality of state and a second score that is calculated based on the updated plurality of quality states.

17. The system of claim 15, wherein the plurality of quality states quantifies a relationship between a service quality of the computing environment and the predetermined level of quality.

18. The system of claim 15, wherein the predetermined level of quality comprises an upper specification limit and a lower specification limit.

19. The system of claim 15, wherein increasing the level of optimality comprises centering a service quality of the computing environment between an upper specification limit and a lower specification limit.

20. The system of claim 15, wherein the computer-readable instructions further cause the system to:
extract an updated plurality of states and an updated plurality of quality states in response to applying the one or more actions to the computing environment;
calculate an optimality score comprising an efficiency of the computing environment based on the updated plurality of states and a level of service quality based on the updated plurality of quality states; and
determine a modified set of one or more actions for application to the computing environment based on the updated plurality of states and the updated plurality of quality states to increase the optimality score.
